(19) United States
(12) Patent Application Publication
(10) Pub. No.: US 2025/0276846 A1
(43) Pub. Date: Sep. 4, 2025

(54) NESTABLE TRASH RECEPTACLE WITH WHEELS

(71) Applicant: Suncast Technologies, LLC, Palm Beach Gardens, FL (US)

(72) Inventors: Stephen Whitehead, Elgin, IL (US); Robert Kopp, Elburn, IL (US); Torrence Anderson, Overland Park, KS (US)

(21) Appl. No.: 18/592,501

(22) Filed: Feb. 29, 2024

(51) Int. Cl. B65F 1/14

(52) U.S. Cl. CPC B65F 1/1473; B65F 2220/12

(57) ABSTRACT

The invention involves a wheeled trash receptacle having wheels slidable on an axle between an inboard position where the trash receptacle may be nested inside of a like constructed trash receptacle and an outboard position where the wheels are spaced further apart to provide for stability of the trash receptacle while being moved on its wheels. The wheel spacer is constructed as a one piece member that can be slid over a side surface of the axle to be positioned on either side of either wheel on the trash receptacle. The construction of the wheel spacer also makes removal of the wheel spacer an easy task should the user want to change the configuration of the trash receptacle at any time.

### FIELD OF INVENTION

The present invention generally relates to trash receptacles and, more particularly, to a wheeled trash receptacle having an adjustable wheel position to allow for nesting of one wheeled trash receptacle inside of another wheeled trash receptacle.

### BACKGROUND INFORMATION

Wheeled trash receptacles are known in the art. They generally assist the user in moving a large and heavy amount of trash or refuse by functioning like a two wheeled cart when loaded with weight. This construction allows the user to tip the can toward the user to place the weight over the wheels. The loaded trash receptacle can then be moved to a desired location before being allowed to fall back onto the bottom surface of the trash can, which may lift the wheels away from the ground surface. Unfortunately, wheeled trash receptacles that include widely spaced wheels for stability are typically not nestable and thus shipment adds significant cost to the consumer product. Wheeled trash receptacles that are nestable typically require the wheels to be moved inward, making the trash receptacle unstable when the wheels are used.

Therefore, current wheeled trash receptacle designs are typically sold without the wheels mounted to the trash can to allow the empty cans to be nested for shipment. Thus, the user must finish assembly of the trash can once purchased and transferred home, requiring tools and small part assembly to complete the trash receptacle. Once assembled, the construction prevents the trash cans from nesting for storage. Thus, the trash s must be stored in a side by side arrangement, consuming a large amount of space.

U.S. Patent Publication No. 2004/0108666 to Rubbermaid discloses a nestable trash can. The trash can includes an elongated slot in which the axle and wheel arrangement is slidably mounted. In this device, the axle and wheels are slid to a rearward position where the wheels can be moved inwardly toward the center of the trash can. In this position, the trash cans can be partially nested. Use of the trash can requires the axle to be moved to a forward position and wheels moved outwardly. This construction creates several problems, one being the elongated slot in the bottom portion of the trash can. Since the axle extends completely across the trash can there is no way to seal the bottom portion of the can. The elongated slot provides a wide open area for animals, such as rats and mice, to enter the trash can, as well as allow fluids to leak from the trash can.

U.S. Pat. No. 11,873,161, also to Rubbermaid, discloses a waste receptacle having wheels that can be moved inwardly and outwardly. The wheels are retained in a respective position with a spacer assembly. The spacer assembly includes two pieces, one having spring lock tabs and the other including a socket for the spring tabs. In use, the axle is moved manually to the inward or the outward position. Once in position, the two pieces of the spacer assembly are positioned to interlock with one another by inserting the spring clips into the sockets. Once inserted and locked together the components cannot be disassembled without breaking the components of the spacer.

Finally, there are ergonomic needs that a wheel spacer must satisfy in order to achieve acceptance by the end user. The system must be easily and quickly assembled using minimal hardware and requiring a minimal number of tools. Further, the system should not require excessive strength to assemble or include heavy component parts. Moreover, the system must assemble together in such a way so as not to detract from the aesthetic appearance of the assembled trash receptacle. Still yet, the wheel spacer should be easily disassembled to allow the user to reconfigure his trash receptacle as needed.

Thus, the present invention provides a wheeled trash receptacle that includes a one piece wheel spacer which overcomes the disadvantages of prior art. The wheel spacer attachment structure of the present invention not only provides for relative ease in the assembly, it also permits disassembly and repositioning of the wheels on the trash receptacle as desired.

### SUMMARY OF THE INVENTION

Briefly, the invention involves a wheeled trash receptacle having wheels slidable on an axle between an inboard position where the trash receptacle may be nested inside of a like constructed trash receptacle and an outboard position where the wheels are spaced further apart to provide for stability of the trash receptacle while being moved on its wheels. The wheel spacer is constructed as a one piece member that can be slid over a side surface of the axle to be positioned on either side of either wheel on the trash receptacle. The construction of the wheel spacer also makes removal of the wheel spacer an easy task should the user want to change the configuration of the trash receptacle at any time.

Accordingly, it is an objective of the present invention to provide a wheeled and nestable trash receptacle.

It is a further objective of the present invention to provide a wheeled and nestable trash receptacle that includes wheels movable between a nestable and a non-nestable position.

It is yet a further objective of the present invention to provide a wheel spacer that can be removed and replaced to change the wheel position between the nestable and the non-nestable position.

It is another objective of the present invention to provide a wheel spacer that snaps over a side surface of the wheel axle.

It is still yet another objective of the present invention to provide a wheel spacer that is constructed as a single member having a ramping surface to allow the wheel spacer to flex when snapped over the side surface of the wheel axle.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a top, front, right perspective view of one embodiment of a wheeled trash receptacle utilizing a one piece wheel spacer;

FIG. 2 is a top, rear, right perspective view of the wheeled trash receptacle utilizing a one piece wheel spacer;

FIG. 3 is a bottom, rear, right view of the wheeled trash receptacle utilizing a one piece wheel spacer;

FIG. 4 is a rear, bottom, left view of the wheeled trash receptacle utilizing a one piece wheel spacer;

FIG. 5 rear is a view of the wheeled trash receptacle utilizing a one piece wheel spacer illustrating the wheels in an outboard position;

FIG. 6 is a right side view of the wheeled trash receptacle utilizing a one piece wheel spacer illustrating the wheels in an outboard position;

FIG. 7 is a bottom view of the wheeled trash receptacle utilizing a one piece wheel spacer illustrating the wheels in an outboard position;

FIG. 8 is a top, rear, right view of the wheeled trash receptacle utilizing a one piece wheel spacer illustrating the wheels in an inboard position;

FIG. 9 is top, rear, left view of the wheeled trash receptacle utilizing a one piece wheel spacer illustrating the wheels in an inboard position;

FIG. 10 is a rear view of the wheeled trash receptacle utilizing a one piece wheel spacer illustrating the wheels in an inboard position;

FIG. 11 is a bottom, rear, left perspective view of the wheeled trash receptacle utilizing a one piece wheel spacer illustrating the wheels in an inboard position;

FIG. 12 is a bottom view of the wheeled trash receptacle utilizing a one piece wheel spacer illustrating the wheels in an inboard position;

FIG. 13 is a top, rear, right perspective view of the axle assembly for the wheeled trash receptacle utilizing a one piece wheel spacer illustrating the wheels in an inboard position on the axle;

FIG. 14 is a top, front, left view of the axle assembly for the wheeled trash receptacle utilizing a one piece wheel spacer illustrating the wheels in an inboard position on the axle;

FIG. 15 is a rear view of the axle assembly for the wheeled trash receptacle utilizing a one piece wheel spacer illustrating the wheels in an inboard position on the axle;

FIG. 16 is a front view of the axle assembly for the wheeled trash receptacle utilizing a one piece wheel spacer illustrating the wheels in an inboard position on the axle;

FIG. 17 is a top, front, left perspective view of the one piece wheel spacer;

FIG. 18 is a bottom, rear, right perspective view of the one piece wheel spacer;

FIG. 19 is a top, front, right perspective view of the one piece wheel spacer;

FIG. 20 is a bottom, rear, left perspective view of the one piece wheel spacer;

FIG. 21 is a rear view of the one piece wheel spacer;

FIG. 22 is a right side view of the one piece wheel spacer;

FIG. 23 is a front view of the one piece wheel spacer;

FIG. 24 is a top view of the one piece wheel spacer;

FIG. 25 is a bottom view of the one piece wheel spacer;

FIG. 26 is a left side view of the one piece wheel spacer;

FIG. 27 is a top, front, right perspective view illustrating the trash receptacles in a nested arrangement;

FIG. 28 is a top, rear, right perspective view illustrating the trash receptacles in a nested arrangement;

FIG. 29 is a front view illustrating the trash receptacles in a nested arrangement;

FIG. 30 is a section view taken along lines 30-30 of FIG. 29;

FIG. 31 is a side view illustrating the trash receptacles in a nested arrangement;

FIG. 32 is a section view taken along lines 32-32 of FIG. 31;

FIG. 33 is a front, bottom, right perspective view illustrating the trash receptacles in a nested arrangement; and

FIG. 34 is a rear, bottom, right perspective view illustrating the trash receptacles in a nested arrangement.

### DETAILED DESCRIPTION OF THE PREFERRED EMBODIMENTS

While the invention present is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

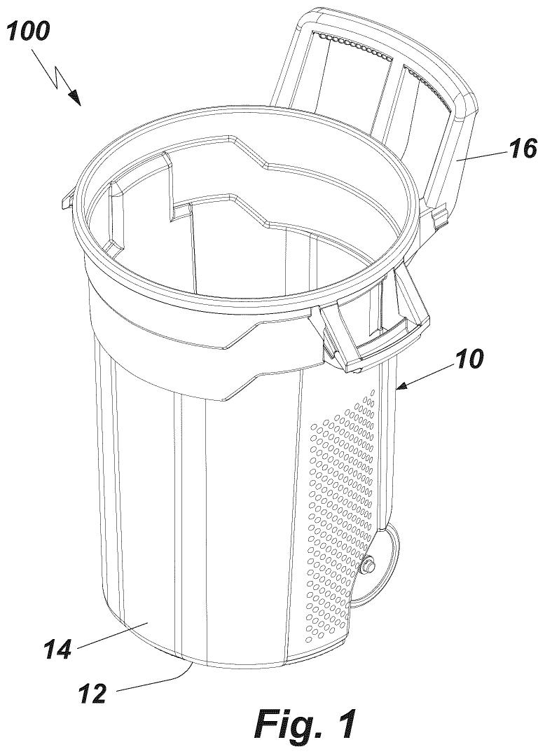

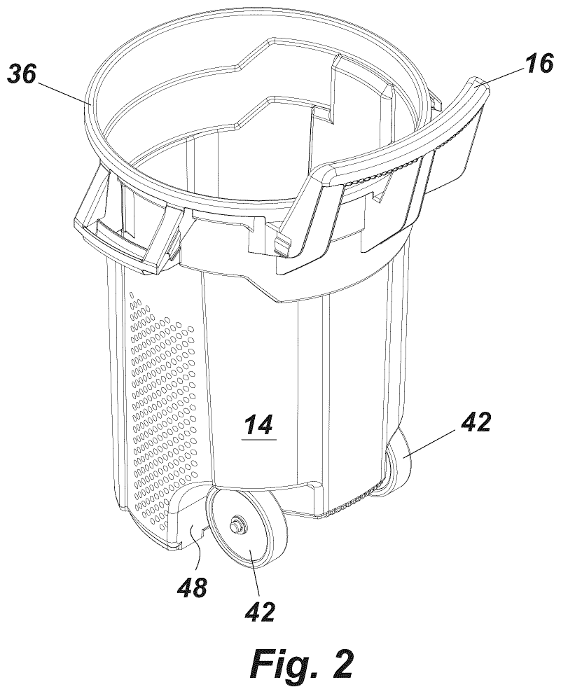

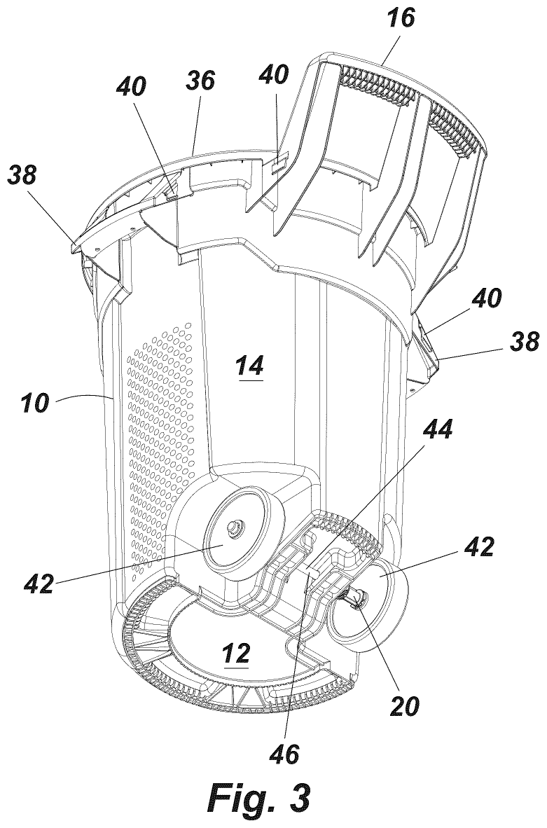

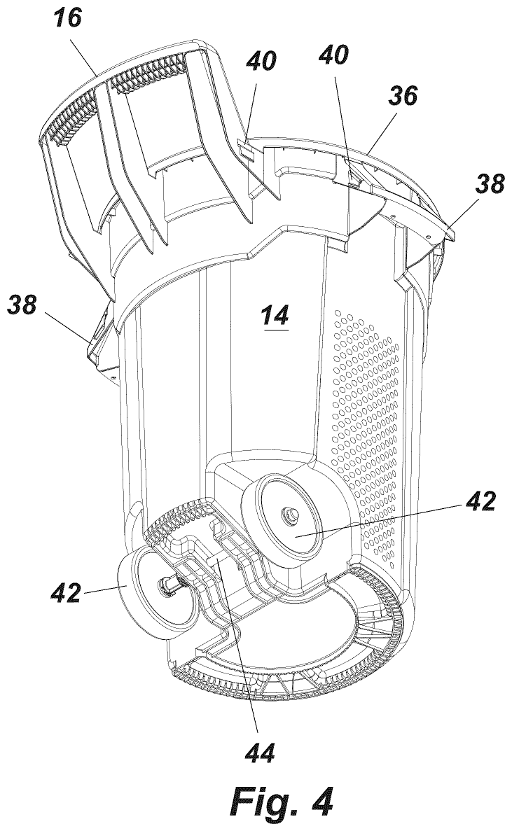

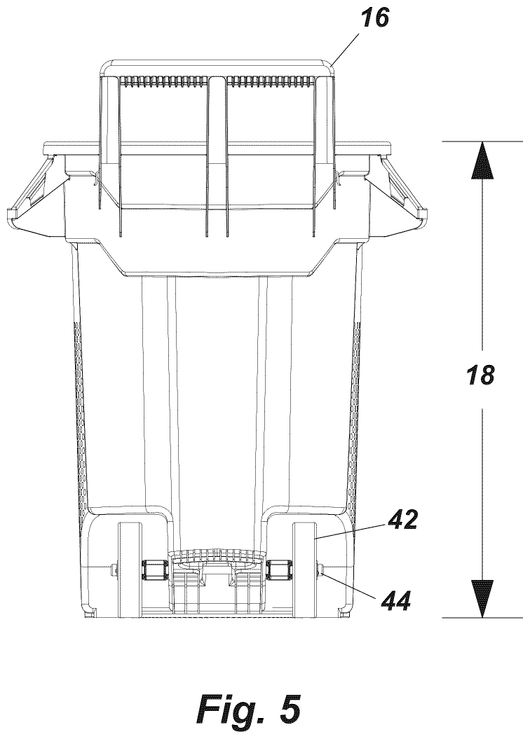

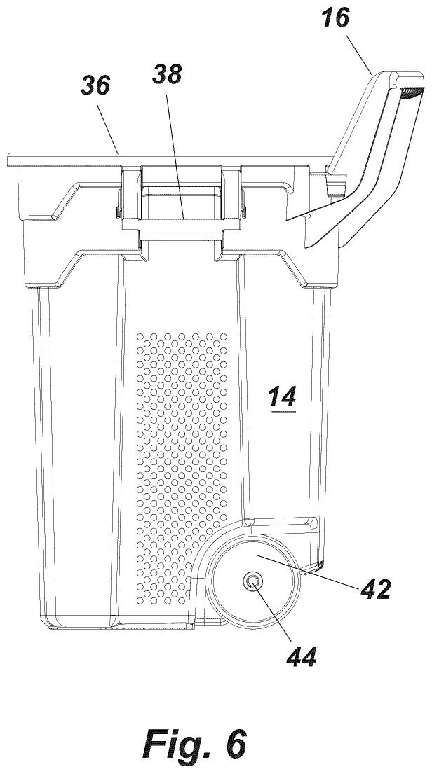

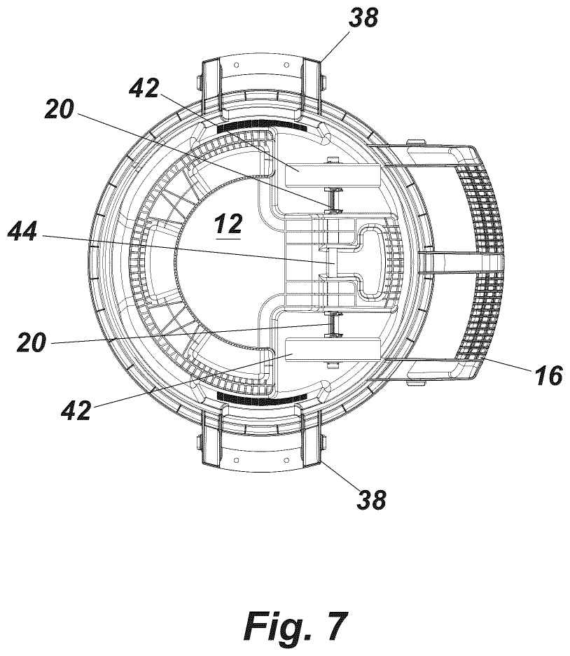

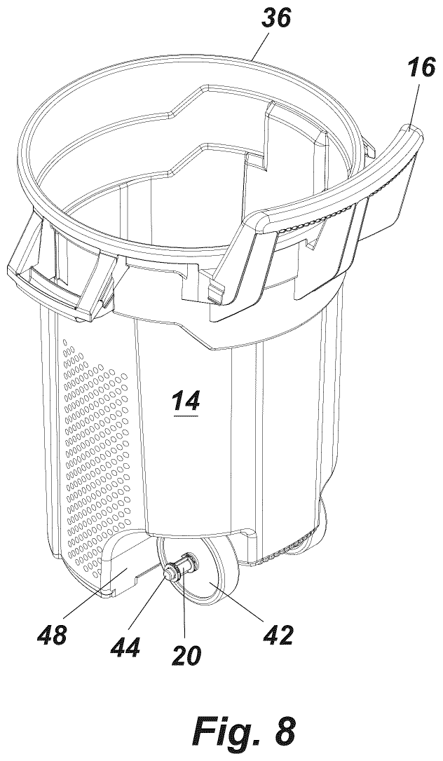

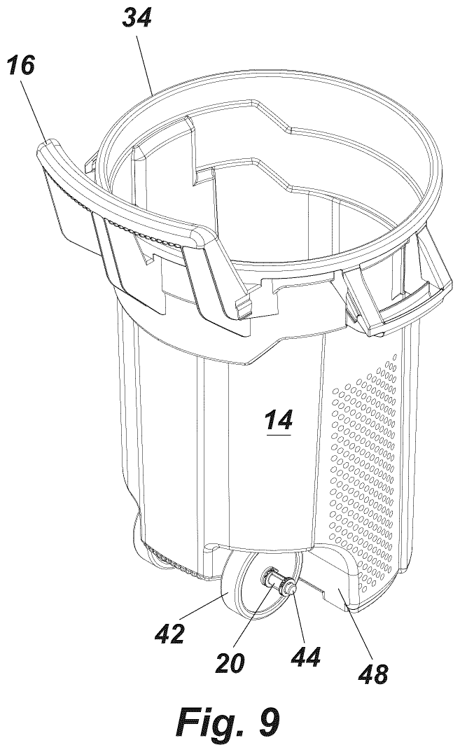

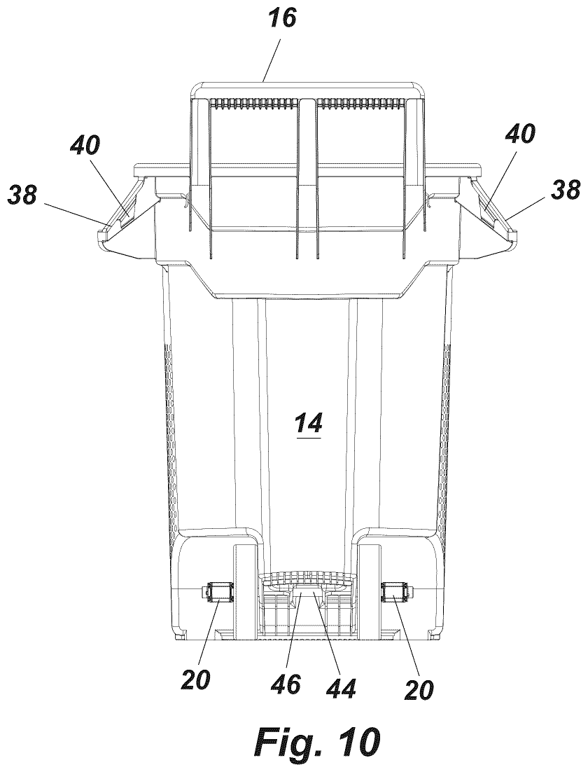

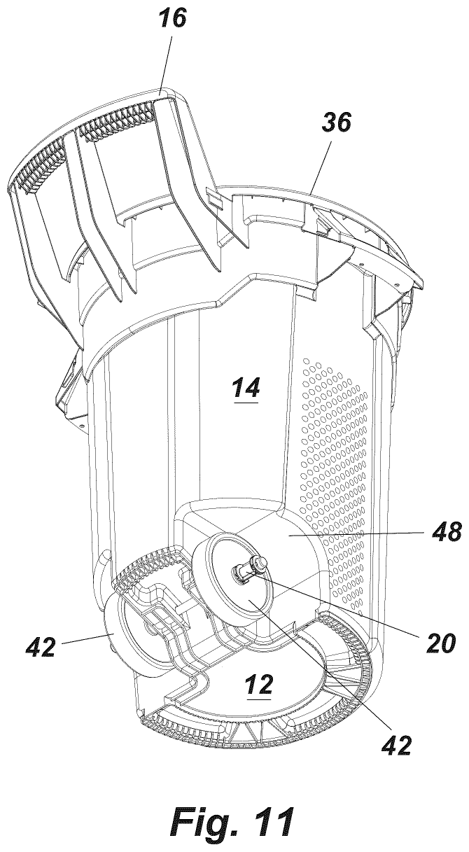

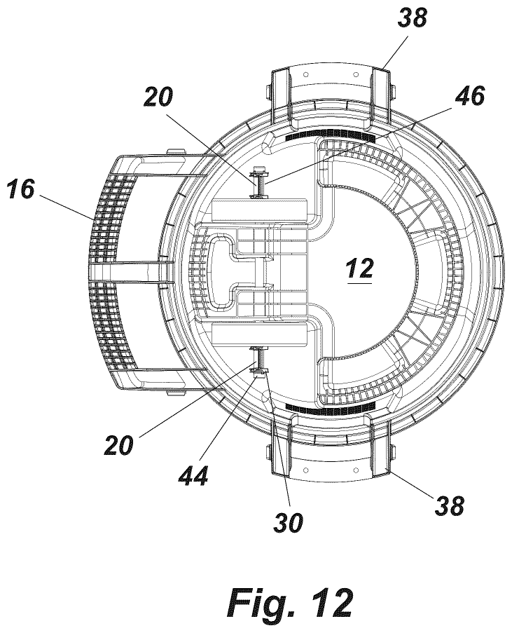

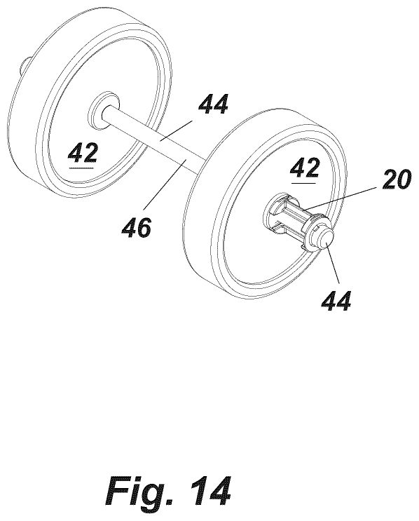

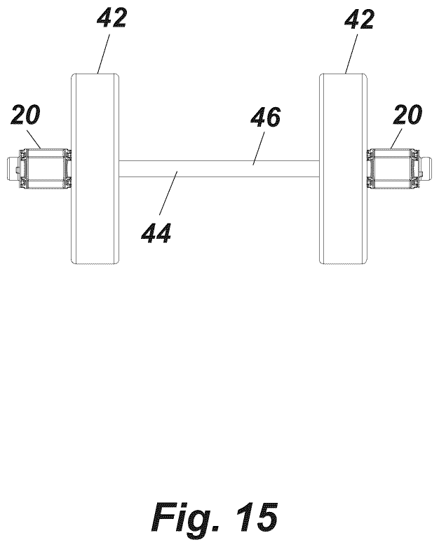

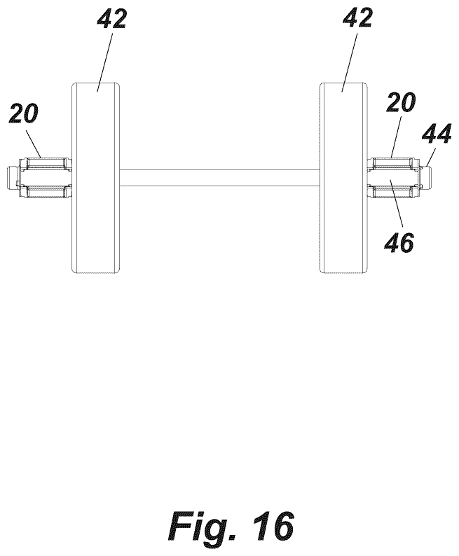

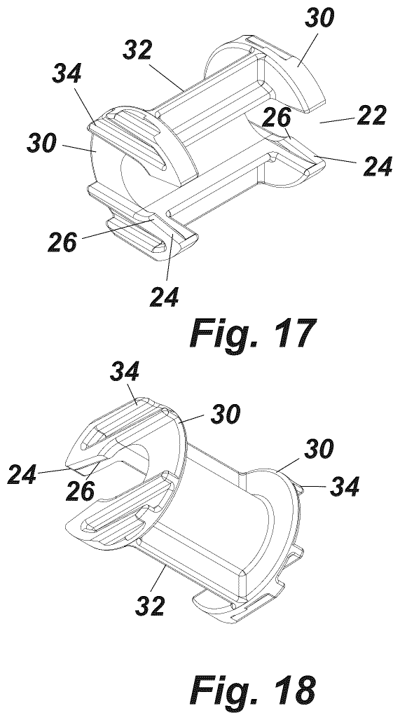

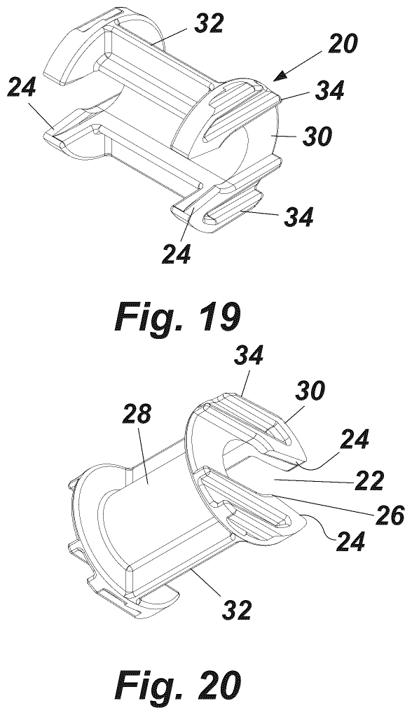

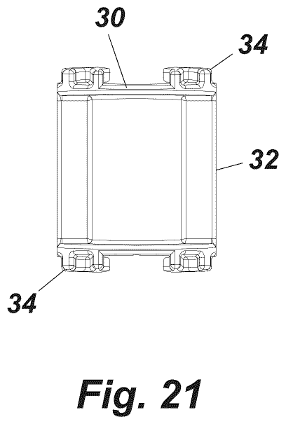

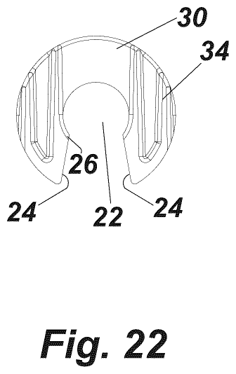

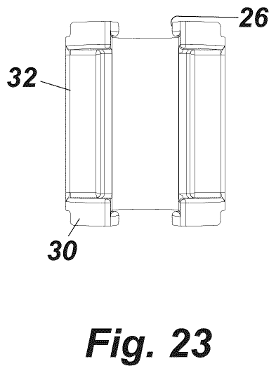

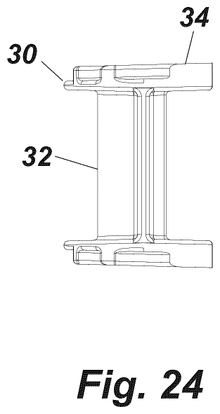

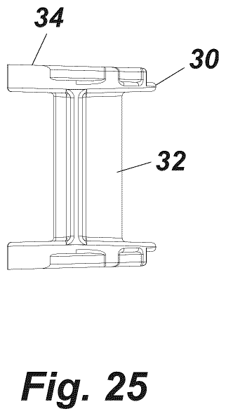

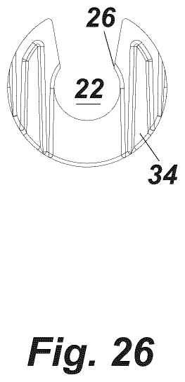

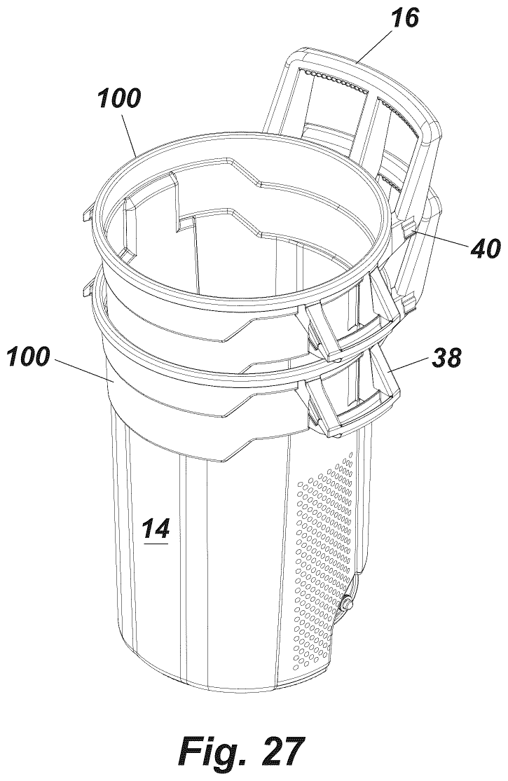

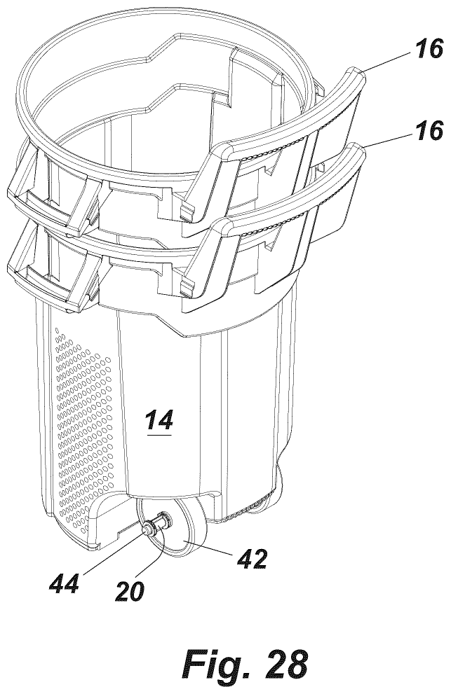

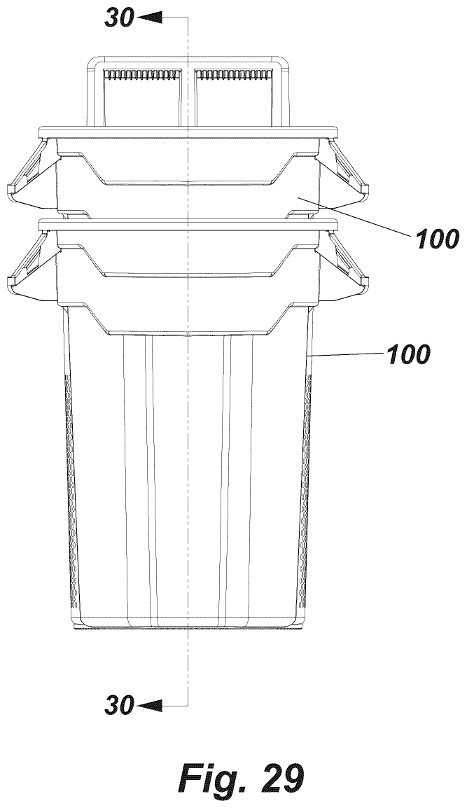

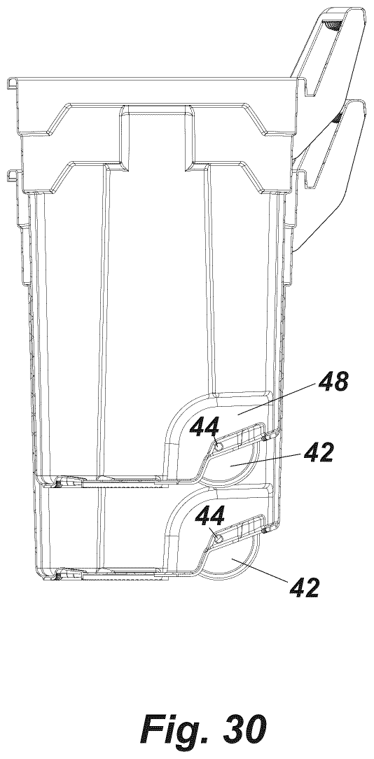

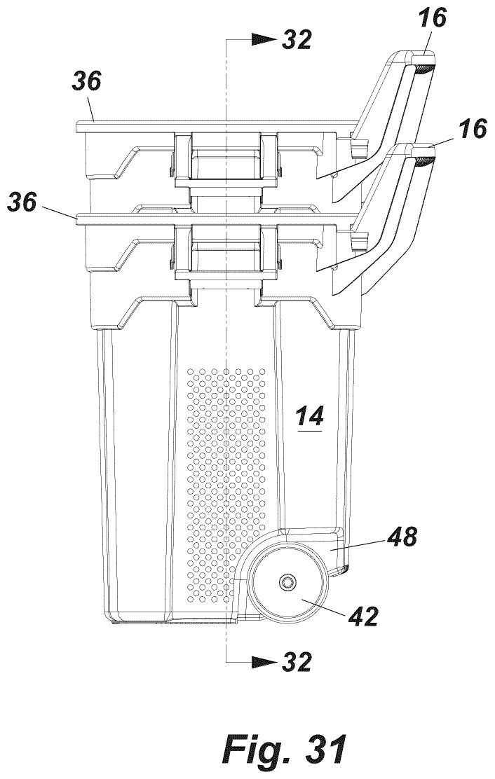

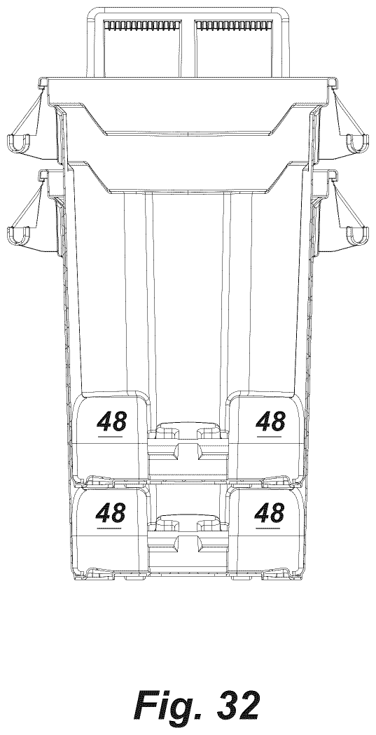

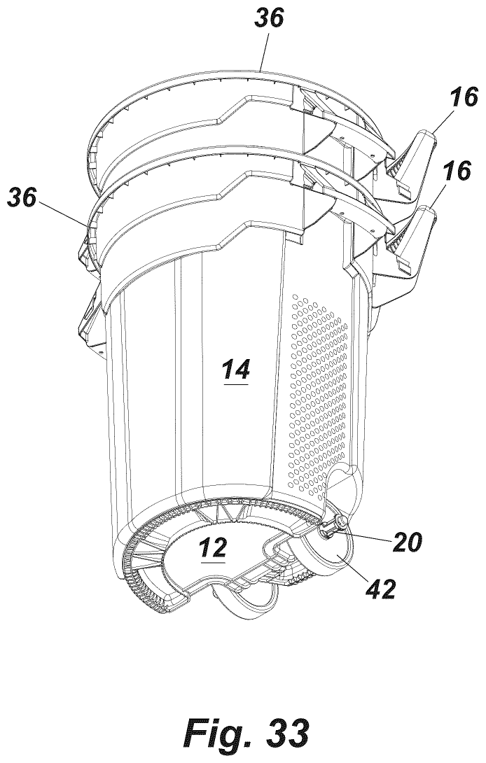

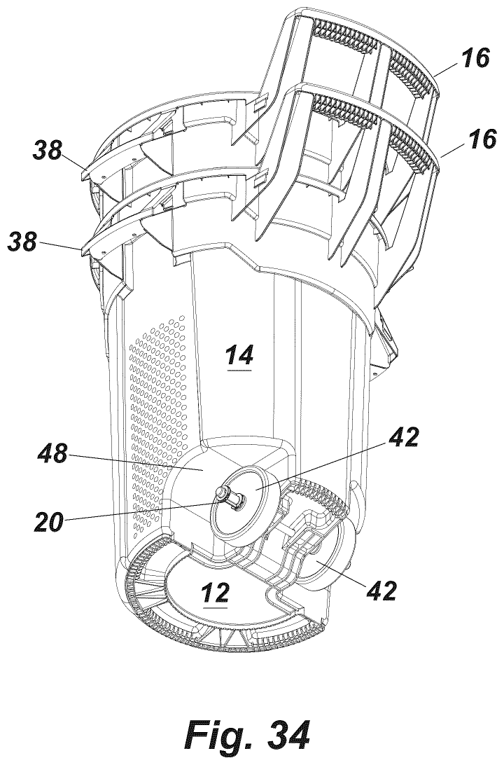

Referring generally to FIGS. 1-34, a wheeled trash receptacle 100 including a receptacle 10 for receiving and holding trash is disclosed, the receptacle 10 including a bottom wall 12 for supporting the receptacle in an upright position when in contact with a ground surface. A sidewall 14 is integrally formed to and extending completely around a perimeter of the bottom wall 12; the sidewall 14 including a height 18 suitable for receiving and holding trash. The sidewall 14 terminates in a rim 36 which extends around the perimeter of the sidewall, generally turning outward and then downward to round off or square off the top surface of the sidewall. One or more side handles 38 may be formed or secured to the sidewall 14 for moving and maneuvering the trash receptacle. In at least some embodiments, one or more of the side handles 38 include a cinch clamp 40 that is constructed and arranged to cooperate with a trash bag (not shown) to hold the trash bag taught when positioned inside of the trash receptacle to receive trash. A main handle 16 is provided at a rear portion of the receptacle 10 for tipping the trash receptacle 100 from a stationary position having the bottom wall 12 against a ground surface to a mobile position wherein the bottom wall is not in contact with the ground surface and a pair of wheels 42 are in contact with the ground surface. The pair of wheels 42 is secured to the receptacle 10 for rotation about an axle 44. The wheels are preferably positioned in a wheel well 48 so as to not contact the ground surface when the receptacle 10 is in the upright position. The wheels are constructed and arranged to have at least two positions, a first wheel position allowing one wheeled trash receptacle to be nested inside of another like constructed trash receptacle, (see FIGS. 8-16 and 27-34), and a second wheel position providing greater stability to the receptacle in the mobile position but not allowing nesting (see FIGS. 1-7). The wheels are configurable by a consumer to be in either the first wheel position or the second wheel position. The wheel position is also changeable at any time by the consumer should they need the trash receptacles to nest for storage or add stability for top heavy loads. In order to provide the changeable wheel position, the trash receptacle is provided with a pair of one piece wheel spacers 20, wherein one wheel spacer 20 is associated with each respective wheel 42 of the pair of wheels to position the respective wheel in the first wheel position or the second wheel position. In a preferred embodiment, each one piece wheel spacer 20 is constructed and arranged to snap over a side surface 46 of the axle 44. Each one piece wheel spacer 20 is resiliently deformable to snap over the side surface 46 of the axle 44 or remove the one piece wheel spacer 20 from the axle 44 by hand. Thus, the consumer can change the position of the wheel spacer 20, and thus the wheel, by repositioning the one piece wheel spacer 20 on either side of a respective wheel 42. As noted above, the removal and placement of the one piece wheel spacer 20 can be completed by hand and not require tools that the consumer may not have access to.

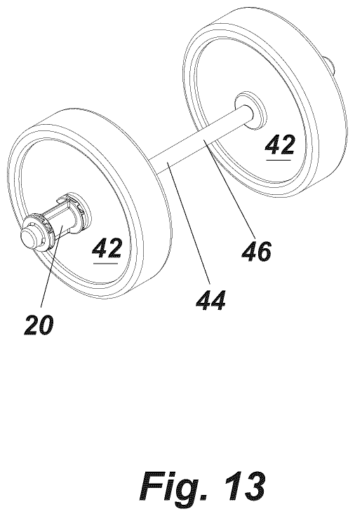

Still referring generally to all of the figures, and more specifically to FIGS. 13-26, the one piece wheel spacer 20 is illustrated. The one piece wheel spacer 20 is preferably C-shaped, when viewed from an end, having a channel 22 for engaging the side surface 46 of the axle 44. The channel 22 includes a ramping surface 24 for causing resilient deformation of the one piece wheel spacer 20 as it is slipped over the cylindrical side surface 46 of the axle 44. In a most preferred embodiment, both sides of the channel 22 include a ramping surface 24 to assist in flexing the one piece spacer 20. The channel 22 preferably includes a mouth portion 26, the mouth portion being narrower than a diameter of the axle 44 to resist removal of the one piece spacer 20 from the axle 44. In at least one embodiment, the one piece spacer 20 is constructed to include a core sleeve 28 and a pair of flanges 30. In a most preferred embodiment, at least one of the flanges 30 includes rub rails 34 for reducing friction with a respective wheel 42. The rub rails 34 are preferably elongated and raised projections that rub against a wheel surface as the wheel rotates. This construction reduces friction when rolling a loaded or unloaded trash receptacle by reducing the contact area between the two components. In addition, the polymer or plastic resin used for construction of the one piece wheel spacer 20 may be selected for lower friction when rubbing against the wheel material. Some embodiments include at least one rib 32 that is integrally formed to and extends between the flanges 30 at each end of the one piece spacer 20 to provide structural rigidity to the one piece spacer 20 while maintaining a reduced weight when compared to a solid construction.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A wheeled trash receptacle comprising:
a receptacle for receiving and holding trash, the receptacle including a bottom wall for supporting the receptacle in an upright position when in contact with a ground surface, a sidewall integrally formed to and extending completely around a perimeter of the bottom wall, the sidewall including a height suitable for receiving and holding trash,
a pair of wheels secured to the receptacle for rotation about an axle, the wheels positioned so as to not contact the ground surface when the receptacle is in the upright position,
a handle for tipping the receptacle to a mobile position wherein the bottom wall is not in contact with a ground surface and the wheels are in contact with the ground surface,
the wheels having at least two positions, a first wheel position allowing one wheeled trash receptacle to be nested inside of another like constructed trash receptacle, a second wheel position providing greater stability to the receptacle in the mobile position but not allowing nesting, the wheels configurable by a consumer in either the first wheel position or the second wheel position.

2. The wheeled trash receptacle of claim 1 including a one piece wheel spacer associated with each respective wheel of the pair of wheels to position the respective wheel in the first wheel position or the second wheel position.

3. The wheeled trash receptacle of claim 2 wherein each one piece wheel spacer is constructed and arranged to snap over a side surface of the axle.

4. The wheeled trash receptacle of claim 3 wherein each one piece wheel spacer is resiliently deformable to snap over the side surface of the axle.

5. The wheeled trash receptacle of claim 4 wherein each one piece wheel spacer is C-shaped having a channel, the channel including a ramping surface for causing resilient deformation of the one piece wheel spacer as it is slipped over the side surface of the axle.

6. The wheeled trash receptacle of claim 5 wherein each side of the channel opening includes a ramping surface.

7. The wheeled trash receptacle of claim 6 wherein the channel includes a mouth portion, the mouth portion being narrower than a diameter of the axle to resist removal of the one piece spacer from the axle.

8. The wheeled trash receptacle of claim 5 wherein the one piece spacer includes a core sleeve and a pair of flanges.

9. The wheeled trash receptacle of claim 8 wherein at least one of the flanges includes rub rails for reducing friction with a respective wheel.

10. The wheeled trash receptacle of claim 9 wherein the rub rails are elongated and raised projections that rub against a wheel surface as the wheel rotates.

11. The wheeled trash receptacle of claim 10 wherein at least one rib 32 is integrally formed to and extends between the flanges 30 at each end of the one piece spacer to provide structural rigidity to the one piece spacer.

12. The wheeled trash receptacle of claim 1 wherein the one piece spacer is constructed from polymer.

13. The wheeled trash receptacle of claim 1 wherein the polymer is plastic resin.
